(19) United States
(12) Patent Application Publication
(10) Pub. No.: US 2026/0089628 A1
(43) Pub. Date: Mar. 26, 2026

(54) METHOD AND APPARATUS FOR INDICATING BANDWIDTH FOR COORDINATED R-TWT IN WIRELESS LAN SYSTEM

(71) Applicant: Samsung Electronics Co., Ltd., Suwon-si (KR)

(72) Inventors: Jungjun KIM, Suwon-si (KR); Taeyoung HA, Suwon-si (KR); Jonghoe KOO, Suwon-si (KR); Suhwook KIM, Suwon-si (KR)

(21) Appl. No.: 19/338,384

(22) Filed: Sep. 24, 2025

(30) Foreign Application Priority Data
Sep. 24, 2024 (KR) 10-2024-0128899

(51) Int. Cl. H04W 52/02

(52) U.S. Cl. CPC H04W 52/0216

(57) ABSTRACT

The disclosure relates to a wireless local area network (WLAN) system. A method and an apparatus for transferring target wake time (TWT) bandwidth information to effectively operate the TWT, and performing frequency division coordinated TWT (C-TWT) between access points (APs) are provided.

### CROSS-REFERENCE TO RELATED APPLICATION(S)

This application is based on and claims priority under 35 U.S.C. § 119(a) of a Korean patent application number 10-2024-0128899, filed on Sep. 24, 2024, in the Korean Intellectual Property Office, the disclosure of which is incorporated by reference herein in its entirety.

### BACKGROUND

### 1. Field

The disclosure relates to a method and an apparatus for transmitting signals in a wireless local area network (WLAN) system. More specifically, the disclosure relates to a method and an apparatus for efficiently performing target wake time (TWT).

### 2. Description of Related Art

A wireless local area network (WLAN), also known as Wireless Fidelity (Wi-Fi), is a network that allows users to access the Internet within a certain distance from an installed access point (AP) by using mobile terminals or laptops. WLAN technology has been continuously evolving with the widespread adoption of the Internet and the expansion of the smartphone market, and the WLAN is used to provide high-speed data services across urban areas, including schools, airports, hotels, and offices.

The Wi-Fi Alliance defines Wi-Fi as WLAN products based on the Institute of Electrical and Electronics Engineers (IEEE) 802.11 standards. Published in 1997 and 1999, respectively, IEEE 802.11a and 802.11b are standards that utilize unlicensed bands at 2.4 GHz or 5 GHz. IEEE 802.11b (also referred to as Wi-Fi 2) provides a transmission speed of 11 Mbps, while IEEE 802.11a (also referred to as Wi-Fi 1) offers 54 Mbps. IEEE 802.11g (also referred to as Wi-Fi 3) applies orthogonal frequency-division multiplexing (OFDM) at 2.4 GHz to achieve a transmission speed of 54 Mbps. IEEE 802.11n (also referred to as Wi-Fi 4 or High Throughput (TH)) employs multiple input multiple output-OFDM (MIMO-OFDM) and thereby provides a transmission speed of 300 Mbps by using four spatial streams. IEEE 802.11n supports a channel bandwidth of up to 40 MHz and, in this case, a transmission speed of 600 Mbps is provided.

Subsequently, the IEEE 802.11ac standard (also referred to as Wi-Fi 5 or Very High Throughput (VHT)) was introduced, supporting the maximum speed of 1 Gbit/s by using up to 160 MHz bandwidth and supporting eight spatial streams, and the IEEE 802.11ax standard (also referred to as Wi-Fi 6 or High Efficiency (HE)) followed, providing multi-user multiple-input multiple-output (MU-MIMO) in the uplink and downlink, and supporting spatial frequency reuse and dynamic fragmentation. Subsequently, the IEEE 802.11be standard (also referred to as Wi-Fi 7 or Extremely High Throughput (EHT)) was introduced, aiming for theoretical speeds of 46 Gbps with support for up to 320 ultra-wide channels, multi-link operations, and 4 k QAM. In addition, the IEEE 802.11bn standard (also referred to as Wi-Fi 8 or Ultra High Reliability (UHR)) is being researched, introducing technologies to optimize spectrum usage and reduce interference through collaboration among multiple APs, technologies to implement power management techniques to reduce energy consumption, and technologies to optimize spectrum allocation.

The above information is presented as background information only to assist with an understanding of the disclosure. No determination has been made, and no assertion is made, as to whether any of the above might be applicable as prior art with regard to the disclosure.

### SUMMARY

In the 802.11 standard, a target wake time (TWT) was defined to reduce power consumption and enhance spectrum efficiency. Coordinated TWT (C-TWT) technology has been researched such that, in order to protect frames transmitted/received during the TWT, respective APs negotiate resource usage primarily in the time domain.

Aspects of the disclosure are to address at least the above-mentioned problems and/or disadvantages and to provide at least the advantages described below. Accordingly, an aspect of the disclosure is to provide a method and an apparatus for negotiating resource usage in the frequency domain.

Additional aspects will be set forth in part in the description which follows and, in part, will be apparent from the description, or may be learned by practice of the presented embodiments.

In accordance with an aspect of the disclosure, a method performed by a first electronic device of a wireless LAN network is provided. The method includes receiving a target wake time (TWT)-related frame including TWT bandwidth information from a second electronic device, occupying a transmission opportunity (TXOP), identifying whether a frequency band of a TWT service period (SP) corresponding to the TWT-related frame, which is to start during occupation of the TXOP, overlaps at least partially with a frequency band of the TXOP, and terminating the TXOP in case that the frequency band of the TWT SP and the frequency band of the TXOP overlap at least partially, wherein the frequency band of the TWT SP is identified based on the TWT bandwidth information.

In accordance with another aspect of the disclosure, a method performed by a second electronic device of a wireless LAN network is provided. The method includes transmitting a target wake time (TWT)-related frame including TWT bandwidth information to a first electronic device, and transmitting/receiving a frame in a TWT SP corresponding to the TWT-related frame.

In accordance with another aspect of the disclosure, a first electronic device of a wireless LAN network is provided. The first electronic device includes a transceiver, and a controller communicatively coupled to the transceiver and configured to: receive a target wake time (TWT)-related frame including TWT bandwidth information from a second electronic device, occupy a transmission opportunity (TXOP), identify whether a frequency band of a TWT service period (SP) corresponding to the TWT-related frame, which is to start during occupation of the TXOP, overlaps at least partially with a frequency band of the TXOP, and terminate the TXOP in case that the frequency band of the TWT SP and the frequency band of the TXOP overlap at least partially, wherein the frequency band of the TWT SP is identified based on the TWT bandwidth information.

In accordance with another aspect of the disclosure, a second electronic device of a wireless LAN network is provided. The second electronic device includes a transceiver, and a controller communicatively coupled to the transceiver and configured to: transmit a target wake time (TWT)-related frame including TWT bandwidth information to a first electronic device, and transmit/receive a frame in a TWT SP corresponding to the TWT-related frame.

A method and an apparatus according to at least one embodiment of the disclosure are advantageous in that, while protecting traffic transmitted/received in the TWT SP, each AP's channel utilization efficiency may be increased.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of a wireless communication network according to an embodiment of the disclosure;

FIG. 2 is a diagram illustrating an example of the structure of an electronic device performing WLAN access according to an embodiment of the disclosure;

FIG. 3 is a diagram illustrating an example of a typical link setup process in a wireless LAN according to an embodiment of the disclosure;

FIG. 4 illustrates examples of hidden nodes and exposed nodes and examples of a request to send (RTS) and a clear to send (CTS) for resolving problems related to hidden nodes and exposed nodes according to various embodiments of the disclosure;

FIG. 5 is a diagram illustrating an example of a frame structure used in an IEEE 802.11 system according to an embodiment of the disclosure;

FIG. 6 is a diagram illustrating an example of a network allocation vector (NAV) configuration according to an embodiment of the disclosure;

FIG. 7 is a diagram illustrating an example of a TXOP according to an embodiment of the disclosure;

FIG. 8 is a diagram illustrating an example of a TWT according to an embodiment of the disclosure;

FIG. 9 is a diagram illustrating an example of coordinated restricted TWT (C-R-TWT) operations in case that APs have different primary channels according to an embodiment of the disclosure;

FIG. 10 is a diagram illustrating an example of a restricted TWT (R-TWT) protection method according to an embodiment of the disclosure in case that APs have different primary channels according to an embodiment of the disclosure;

FIG. 11 is a diagram illustrating an example of a TWT bandwidth information field according to an embodiment of the disclosure;

FIG. 12 is a diagram illustrating another example of a TWT bandwidth information field according to an embodiment of the disclosure;

FIG. 13 is a diagram illustrating an example of TWT bandwidth information included in in a broadcast TWT parameter set field for R-TWT according to an embodiment of the disclosure;

FIG. 14A is a diagram illustrating an example of a newly defined extended TWT element according to an embodiment of the disclosure;

FIG. 14B is a diagram illustrating an example in which TWT bandwidth information is included in a multi-AP coordination (MAPC) element exchanged when negotiating or establishing a Co-RTWR between APs according to an embodiment of the disclosure;

FIG. 15 is a diagram illustrating an example of operations of a shared AP performing according to an embodiment of the disclosure; and

FIG. 16 is a diagram illustrating an example of operations of a sharing AP performing according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

Various embodiments are described below with respect to wireless LAN systems for the sake of simplicity. It should be understood that these various embodiments are equally applicable to other wireless networks (e.g., cellular networks, pico networks, femto networks, satellite networks) as well as systems utilizing signals of one or more wired standards or protocols (e.g., Ethernet and/or HomePlug, PLC standards). As used herein, the terms WLAN and Wi-Fi® may encompass communications governed by the IEEE 802.11 family of standards, BLUETOOTH®, HiperLAN (a set of wireless standards primarily used in Europe, comparable to IEEE 802.11 standards), and other technologies with relatively short radio wave ranges. Accordingly, the terms WLAN and Wi-Fi may be used interchangeably in this specification. Furthermore, while the following describes an infrastructure WLAN system including one or more APs and multiple wireless stations (STAs), the various embodiments are equally applicable to other WLAN systems, including multiple WLANs, peer-to-peer (or independent basic service set) systems, Wi-Fi Direct systems, and/or hotspots.

Additionally, while this specification describes the exchange of data frames between wireless devices, various embodiments may be applied to the exchange of any data units, packets, and/or frames between wireless devices. Thus, the term “frame” may encompass any frame, packet, or data unit, such as protocol data units (PDUs), media access control (MAC) protocol data units (MPDUs), and physical layer (PHY) protocol data units (PPDUs). The term “A-MPDU” may refer to aggregated MPDUs. As used herein, a wireless LAN or WLAN network may be a network implementing at least one of the IEEE 802.11 wireless communication protocol standards, as defined by the IEEE 802.11-2016 specification or its amendments (including, but not limited to, 802.11ah, 802.11ad, 802.11ay, 802.11ax, 802.11az, 802.11ba, and 802.11be).

In the following description, numerous specific details, such as examples of specific components, circuits, and processes, are provided to offer a thorough understanding of the disclosure. The term “connected,” as used herein, refers to a direct connection or a connection through one or more intervening components or circuits. The term “connected AP” refers to an access point with which a given wireless station is currently associated and/or connected (e.g., there exists an established communication channel or link between the access point and the given wireless station). In addition, in the following description and for purposes of description, specific nomenclature is presented to provide a thorough understanding of the various embodiments. However, it will be apparent to those skilled in the art that these specific details may not be required to practice the various embodiments. In other instances, to avoid obscuring the disclosure, well-known circuits and devices are shown in block diagram formats. Furthermore, the notation A/B means A and/or B, or at least one of A or B.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

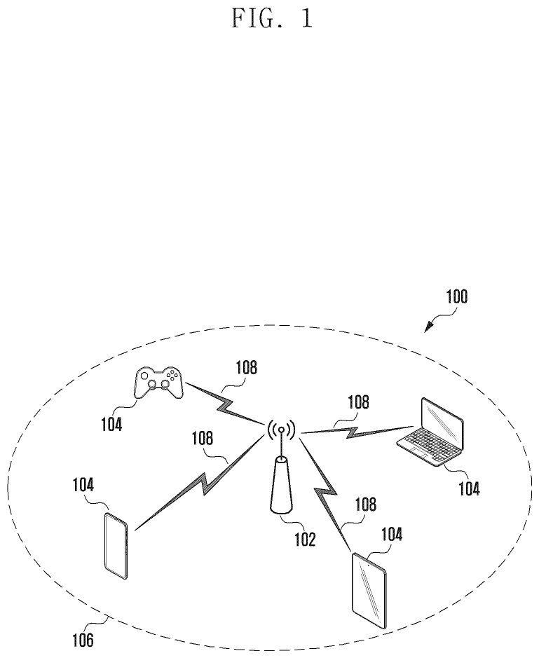

FIG. 1 is a diagram illustrating an example of a wireless communication network according to an embodiment of the disclosure. The wireless communication network 100 may be an example of a wireless LAN, such as a Wi-Fi network. The wireless communication network 100 may include multiple wireless communication devices, such as an access point AP 102 and multiple stations STAs 104. Although only one AP 102 is shown, the wireless communication network 100 may also include multiple APs 102.

An STA is a logical entity that includes a MAC and a physical layer interface regarding the wireless medium, encompassing an AP and a non-AP station (non-AP STA). Among STAs, a portable UE operated by a user is classified as a non-AP STA, and the term “STA” may simply refer to a non-AP STA. Hereafter, an STA may refer to a non-AP STA. Each of the STAs 104 may be referred to as a UE or a device.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet home appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. As used herein, the terminal may also be referred to as an electronic device or simply as a device.

The AP 102 is an entity that provides an associated station (STA) with access to a distribution system DS via a wireless medium. The AP may also be referred to as a central controller, a base station BS, a node-B, a base transceiver system BTS, or a site controller.

A coverage area 106 of the AP 102, which may represent the basic service area (BSA) of the wireless communication network 100, is illustrated. The AP 102 periodically broadcasts beacon frames (which may be used interchangeably with “beacons”) containing a basic service set identifier BSSID to enable any STAs 104 within the wireless range of the AP 102 to become associated or reassociated with the AP 102, thereby establishing individual communication links 108 (which may also be called Wi-Fi links) with the AP 102, or maintaining the communication links 108 with the AP 102. The AP 102 may provide access to external networks regarding various STAs 104 within the WLAN through the individual communication links 108.

A single AP 102 and an associated set of STAs 104 may be referred to as a basic service set (BSS) managed by the individual AP 102. The BSS may be identified to users by a service set identifier (SSID) and to other devices by a BSSID, which may be the MAC address of the AP 102.

BSSs may be classified into an infrastructure BSS and an independent BSS (IBSS). The BSS illustrated in FIG. 1 is an IBSS, and it is also possible to establish an infrastructure BSS (not shown). An infrastructure BSS includes one or more STAs and an AP. In an infrastructure BSS, communication between non-AP STAs is generally routed through the AP. However, in case that a direct link is established between non-AP STAs, direct communication between the non-AP STAs is also possible.

Multiple infrastructure BSSs may be interconnected through a DS. Multiple BSSs connected via the DS are referred to as an extended service set (ESS). STAs within the same ESS may communicate with each other, and an STA move from one BSS to another while maintaining seamless communication within the same ESS.

The DS is a mechanism for connecting multiple APs, and it is not necessarily required to be a network. There are no restrictions on the type thereof as long as the same can provide a predetermined distribution service. For example, the DS may be a wireless network, such as a mesh network, or a physical structure that interconnects APs.

In addition, the AP 102 and the STA 104 may be referred to as an access point multi-link device (AP-MLD) and a STA-MLD, respectively. This may indicate that the AP and STA can support multi-link operations.

The following describes an example of a layer structure according to the 802.11 standard document.

The 802.11 standard document develops MAC and PHY protocols corresponding to Wi-Fi wireless access technology. The data link layer (DLL) includes the MAC sublayer, which is responsible for medium access control. The MAC sublayer receives packets from the 802.1X Port Filtering (upper layer) via the MAC_SAP interface, configures the packets into IEEE 802.11 MAC frames, and forwards the same to the physical layer. The physical layer includes a physical layer convergence procedure (PLCP) sublayer and a physical medium dependent (PMD) sublayer. The PLCP sublayer configures IEEE 802.11 MAC frames configured by the MAC sublayer into PLCP frames. The PLCP frames are then transmitted to the counterpart UE through the PMD sublayer.

Various management frames for managing Wi-Fi wireless access are not forwarded from the 802.1X upper layer. These management frames are transmitted as requests and responses between station management entities (SMEs) located within each UE. The SME is a layer-independent entity that may reside within a separate management plane or appear to be off to the side. For example, when an AP intends to configure a BSS, the AP instructs beacon transmission through the MLME_SAP interface, specifically via the MLME-START.request and MLME-START.confirm primitives. In case that an STA intends to associate with the AP, the STA instructs the transmission of association request/response frames through the MLME-ASSOCIATE.request, MLME-ASSOCIATE.response, MLME-ASSOCIATE.confirm, and MLME-ASSOCIATE.indication primitives. Meanwhile, in case that the SME intends to configure operational factor values related to the physical layer, the same may configure various physical layer factor values through the PLCP_SAP interface.

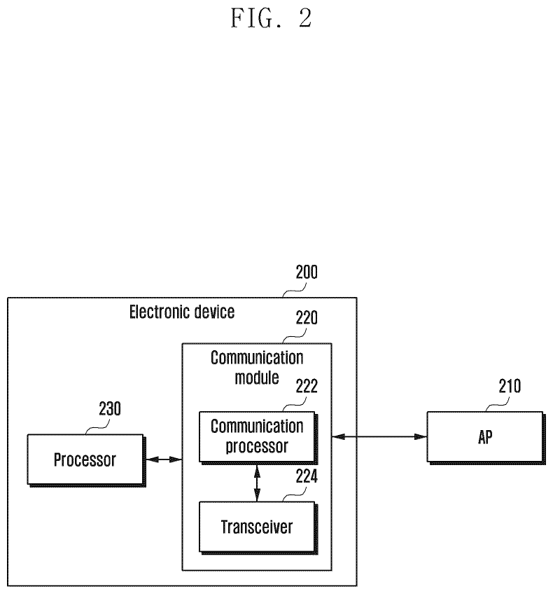

FIG. 2 is a diagram illustrating an example of the structure of an electronic device performing WLAN access according to an embodiment of the disclosure.

Referring to FIG. 2, the electronic device 200 may connect to an AP 210, and may include a processor 230 and a communication module 220. The electronic device 200 may be the STA 104 of FIG. 1, in which case the electronic device 200 may connect to the AP 210 as shown. Alternatively, the electronic device 200 may be the AP 102 of FIG. 1, in which case the electronic device may connect to the STA 104 and/or other APs as in FIG. 1.

The communication module 220 may receive communication signals from the outside or transmit communication signals to the outside, based on a Wi-Fi communication scheme (e.g., IEEE Std 802.11™). For example, the communication module 220 may operate based on IEEE 802.11ac, 802.11ax, 802.11be, or 802.11bn, among Wi-Fi communication schemes. Particularly, IEEE 802.11be or 802.11bn offers improved performance compared to IEEE 802.11ax, by supporting wider bandwidth, higher data throughput, and shorter latency.

The communication module 220 may include a transceiver 224 for transmitting/receiving data with an external device and a communication processor 222 (e.g., a communication processor (not shown) or a short-range wireless communication module such as a Wi-Fi chipset). According to various embodiments, the communication module 220 may further include memory.

According to various embodiments, the transceiver 224 may convert a baseband transmission signal into a radio signal or convert a received radio signal into a baseband reception signal.

According to various embodiments, the communication module 220 may further include components for OFDM or orthogonal frequency division multiple access (OFDMA), such as a modulator, a digital-to-analog (D/A) converter, a frequency converter, an analog-to-digital (A/D) converter, an amplifier, and/or a demodulator, in addition to the transceiver 224 and communication processor 222.

Although not shown, according to various embodiments, the electronic device 200 may include at least one antenna module that is electrically connected to the communication module of the AP 210 and supports the communication protocol and/or frequency band supported by the communication module of the AP 210.

The communication processor 222 may control the transceiver 224 to establish a communication connection with the AP 210. For example, the communication connection may include a Wi-Fi network. For instance, the communication processor 222 may control the transceiver 224 to form a wireless connection with the AP 210 by using WLAN standards in the 2.4 GHZ, 5 GHZ, or 6 GHz bands, such as IEEE 802.11ac, 802.11ax, 802.11be, or 802.11bn. Alternatively, the communication processor 222 may control the transceiver 191 to form a wireless connection with the AP 210 by using WLAN standards in the 60 GHz band, such as IEEE 802.11ad or 802.11ay. In addition, the scheme of communication between the electronic device 200 and the AP 210 using WLAN standards may be referred to as a communication scheme based on the STA mode.

According to various embodiments, the processor 230 may include an application processor. The processor 230 may perform specified operations of the electronic device 200 or may control other hardware (e.g., the communication module 220) to perform specified operations.

According to various embodiments, the AP 210 may support the operation of transmitting packets to an external network (e.g., the Internet, an external LAN, or a cellular network) and/or the operation of multiple electronic devices (e.g., the electronic device 200) receiving packets from the external network, based on the connection between the multiple electronic devices and the external network.

For example, the AP 210 may be a wireless router. The AP 210 may be a dedicated wireless router or a general-purpose device supporting mobile hotspot functionality, with no limitation on the implementation thereof. For example, the AP 210 may include the same components as the electronic device 200 (e.g., a processor and/or communication module). In addition, the AP 210 may transmit/receive data with an external device, such as a server. For example, the AP 210 may transmit at least a part of the data received from the server to the electronic device 200.

In case that the electronic device 200 of FIG. 2 corresponds to the AP 102, the electronic device 200 may include a separate communication module for connection with an external network, although not shown. Such a communication module may be controlled by the processor 230 or controlled by a separate processor. The separate communication module may include a transceiver and a processor, and may further include memory. In addition, the electronic device 200 may include a separate antenna module or a wired connection device for connection with the external network.

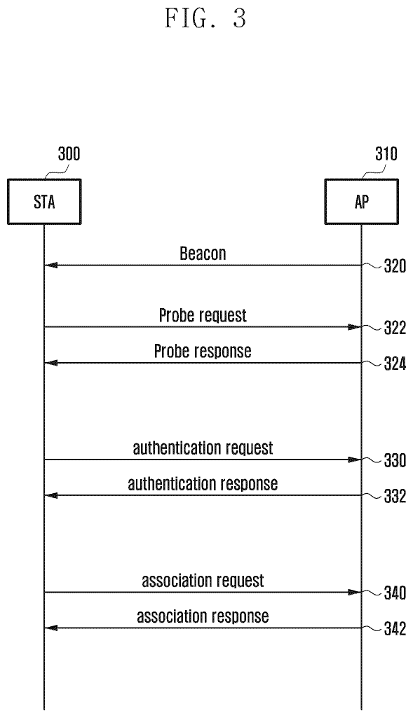

FIG. 3 is a diagram illustrating an example of a typical link setup process in a wireless LAN according to an embodiment of the disclosure.

In order to set up a link with a network and transmit/receive data, an STA must first discover the network, perform authentication, establish an association, and undergo security authentication procedures. The link setup process may also be referred to as a session initiation process or a session setup process. In addition, the discovery, authentication, association, and security setup processes of the link setup process may collectively be called association processes.

Referring to FIG. 3, the STA 300 may perform a network discovery operation. This network discovery operation may include a scanning operation by the STA 300. That is, to access a network, the STA 300 must identify available networks. Before joining a wireless network, the STA 300 must identify compatible networks, and the process of identifying networks in a specific area is called scanning.

Scanning schemes include active scanning and passive scanning. In active scanning, the STA 300 that performs the scanning transmits a probe request frame 322 while switching channels to search for nearby APs and awaits a response. A responder transmits a probe response frame 324 to the STA that sent the probe request frame as a response to the probe request frame. The responder may be the AP or STA that last transmitted a beacon frame in the BSS of the scanned channel. FIG. 3 illustrates an example of a BSS where the AP 310, which transmits the beacon frame 320, acts as the responder. In an IBSS, however, the STAs within the IBSS take turns transmitting beacon frames, so the responder is not fixed. For example, if an STA transmits a probe request frame on channel no. 1 and receives a probe response frame on channel no. 1, the STA may store the BSS-related information included in the received probe response frame and move to the next channel to perform scanning in the same manner.

The scanning operation may also be performed using a passive scanning scheme. In passive scanning, the STA that performs the scan detects beacon frames while switching channels. A beacon frame, one of the management frames in IEEE 802.11, is periodically transmitted to announce the presence of a wireless network and enable the scanning STA to discover and join the wireless network. FIG. 3 illustrates an example of a BSS where the AP 310 periodically transmits a beacon frame 320 to the STA 300. In an IBSS, however, the STAs within the IBSS take turns transmitting beacon frames. Upon receiving a beacon frame, the scanning STA stores the BSS-related information contained in the beacon frame and moves to other channels, recording beacon frame information in each channel. Comparing active and passive scanning, active scanning offers the advantages of lower delay and reduced power consumption compared to passive scanning.

After the STA 300 discovers a network, an authentication process may be performed. This authentication process, to be clearly distinguished from the security setup operation 350 described later, may be referred to as the first authentication process. The authentication process includes processes in which the STA 300 transmits an authentication request frame 330 to the AP 310, and the AP 310 transmits an authentication response frame 332 to the STA 300 in response thereto. The authentication frames used for the authentication request/response correspond to management frames.

An authentication frame may include information regarding the authentication algorithm number, the authentication transaction sequence number, the status code, the challenge text, the robust security network (RSN), the finite cyclic group, and the like. These are examples of information that may be included in the authentication request/response frames and may be replaced with other information or may further include additional information.

The AP 310 may determine whether to permit authentication regarding the corresponding STA, based on the information contained in the received authentication request frame. The AP 310 may provide the result of the authentication processing to the STA 300 through an authentication response frame.

After the STA is successfully authenticated, an association process may be performed. The association process includes processes in which the STA 300 transmits an association request frame 340 to the AP 310, and the AP 310 transmits an association response frame 342 to the STA 300 in response thereto.

For example, the association request frame may include information related to various capabilities, information regarding the listen interval, the SSID, the supported rates, the supported channels, the robust security network (RSN), the mobility domain, the supported operating classes, the traffic indication map (TIM) broadcast request, interworking service capability, and the like.

For example, the association response frame may include information related to various capabilities, information regarding the status code, the association ID (AID), the supported rates, the enhanced distributed channel access (EDCA) parameter set, the received channel power indicator (RCPI), the received signal to noise indicator (RSNI), the mobility domain, the timeout interval (association comeback time), the overlapping BSS scan parameter, the TIM broadcast response, the QoS map, and the like.

These are examples of information that may be included in the association request/response frames and may be replaced with other information or may further include additional information.

Although not shown, after the STA is successfully associated with the network, a security setup process may be performed. The security setup process may also be referred to as an authentication process through a robust security network association (RSNA) request/response. The authentication process 330 may be called the first authentication process, and the security setup process may also be referred to as an authentication process.

The security setup process may, for example, include a process of setting up a private key through 4-way handshaking by using an extensible authentication protocol over LAN (EAPOL) frame, or may be performed according to a security scheme not defined in the IEEE 802.11 standard.

The following describes medium access control protocols provided by IEEE 802.11.

In a wireless LAN system according to IEEE 802.11, the basic access mechanism of the MAC is based on the distributed coordination function (DCF), which utilizes the carrier sense multiple access with collision avoidance (CSMA/CA) scheme. The DCF senses carriers using two methods: physical carrier sensing and virtual carrier sensing. The physical carrier sensing method involves the physical layer sensing the channel state and informing the MAC layer thereof, while the virtual carrier sensing method involves broadcasting the channel occupancy time to surrounding stations to reserve the channel in advance. An STA or AP that secures a transmission channel records this channel occupancy time in an RTS and/or a CTS or a data frame and transmits the same. Upon receiving this, other STAs determine that the channel is in use during this time and refrain from competing for channel occupancy, thereby avoiding collisions.

The physical carrier sensing method basically employs a listen-before-talk access mechanism. According to this type of access mechanism, an AP and/or an STA may perform clear channel assessment (CCA) by sensing the wireless channel, carrier, or medium for a predetermined time interval before initiating transmission. The predetermined time interval is referred to as an inter-frame space (IFS) and may vary depending on the priority of the traffic to be transmitted. That is, the length of the time interval may determine the priority, with higher-priority packets potentially having a shorter time interval.

The IFS may include a short IFS (SIFS), a PCF IFS (PIFS), a DCF IFS (DIFS), and an arbitration IFS (AIFS). The SIFS, which is the shortest time interval, may be primarily used as a waiting time regarding control information. The PIFS, which is an intermediate-length time interval, may relate to packets with a medium priority level (PIFS=SIFS+1 slot time). The DIFS, which is the longest time interval compared to the SIFS and PIFS, has a lower priority and may be mainly used as a waiting time to check whether the channel is used (DIFS=SIFS+2 slot times). For example, an STA that intends to perform transmission may listen to (or sense) whether the channel is used during the DIFS period.

If the sensing result indicates that the medium is in an idle status, the AP and/or STA begin frame transmission through the medium. Conversely, if the medium is detected in an occupied status, the AP and/or STA may not start transmission therefrom and may configure a delay period (e.g., a random backoff period) for medium access, wait, and then attempt frame transmission. For example, the AP and/or STA randomly selects a timer value within the contention window (CW) range, waits until the timer expires, and then again senses the channel. In case that the medium is idle, the AP and/or STA may start frame transmission. In case that the medium is occupied, the AP and/or STA doubles the size of the contention window and selects a new timer value. The initially applied size of the contention window is referred to as the minimum contention window (CWₘᵢₙ), and the maximum applicable size of the contention window is referred to as the maximum contention window (CWₘₐₓ). By applying a random backoff period, it is expected that multiple STAs will wait for different durations before attempting frame transmission, thereby minimizing collisions.

However, this DCF scheme, which does not consider priorities among STAs, has a problem in that it is difficult to support various data transmission types and quality of service (QoS). To address this problem, the hybrid coordination function (HCF) was introduced. The HCF is based on the aforementioned DCF and a point coordination function (PCF). The PCF refers to a polling-based synchronous access scheme where all receiving APs and/or STAs are periodically polled so as to be able to receive data frames. The HCF includes enhanced distributed channel access (EDCA), which a contention-based channel access method, and HCF controlled channel access (HCCA), which is a non-contention-based scheme using a polling mechanism. In addition, the HCF incorporates a medium access mechanism to enhance the WLAN's QoS, enabling the transmission of QoS data during both contention periods (CP) and contention-free periods (CFP).

According to the EDCA, data carries a priority from 0 to 7, based on the traffic type, and data arriving at the MAC layer is mapped to one of four access categories (AC) according to the priority. Higher priority values indicate greater priority, and the ACs have respective AC parameters. Backoff is performed by using differently configured AC parameter values, allowing data to have different channel access priorities based on the ACs. AC parameters may include AIFS, CWₘᵢₙ, CWₘₐₓ, TXOP limits, and the like. Smaller AIFS and CWₘᵢₙ values indicate higher priority, resulting in shorter channel access delays and enabling data to utilize more bandwidths in a given traffic environment. In case that a collision occurs between STAs during frame transmission, the EDCA backoff process for generating a new backoff counter is similar to the legacy DCF, and ensures transmission based on traffic priority through EDCA parameters that include AC-specific priorities.

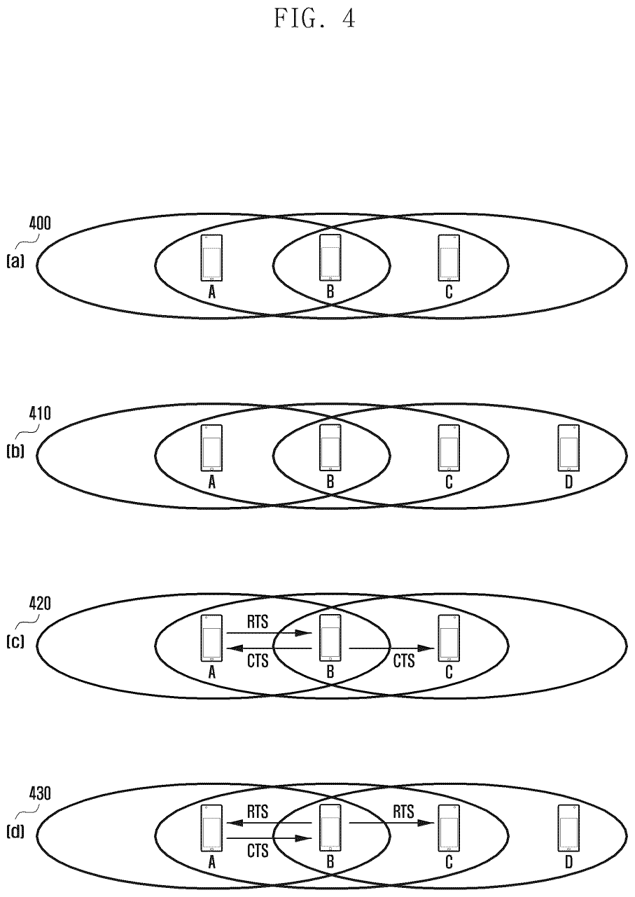

FIG. 4 illustrates examples of hidden nodes and exposed nodes and examples of an RTS and a CTS for resolving problems related to hidden nodes and exposed nodes according to various embodiments of the disclosure.

400 in FIG. 4 shows an example of a hidden node. In case that STA A and STA B are communicating, and STA C has information to transmit, it may be determined that, although STA A is transmitting information to STA B, the medium is idle when STA C performs carrier sensing before sending data to STA B. This is because STA C may not sense transmission from STA A (i.e., medium occupancy) from its location. In this case, STA B receives information from STA A and STA C simultaneously, leading to a collision. In this regard, STA A may be considered a hidden node of STA C.

410 in FIG. 4 shows an example of an exposed node. STA B is transmitting data to STA A, and STA C may have information to transmit to STA D. In this case, if STA C performs carrier sensing, it may determine the medium is occupied due to the transmission from STA B. As a result, STA C must wait until the medium becomes idle, even though it has information to transmit to STA D. However, since STA A is actually outside the transmission range of STA C, the transmission from STA C and the transmission from STA B may not collide from the standpoint of STA A. Thus, STA C unnecessarily waits until STA B stops transmitting. In this regard, STA C may be considered an exposed node of STA B.

In order to efficiently use a collision avoidance mechanism in the aforementioned situations, short signaling packets such as a request to send (RTS) and a clear to send (CTS) may be used. A STA intending to transmit data transmits an RTS to the STA supposed to receive the data, and the receiving STA that has received the RTS responds to the transmitting STA with a CTS frame. The RTS and/or CTS between the two STAs may be overheard by surrounding STA(s), enabling the surrounding STA(s) to consider whether information is transmitted between the two STAs.

420 in FIG. 4 shows an example of a method to resolve the hidden node problem. Assuming both STA A and STA C intend to transmit data to STA B, STA A sends an RTS to STA B, and STA B sends a CTS to STA A. STA C, which overhears the RTS and CTS, delays its own medium access until the data transmission between STA A and STA B is complete, thereby avoiding a collision.

430 in FIG. 4 shows an example of a method to resolve the exposed node problem. STA B, intending to transmit data to STA A, sends an RTS, and STA A, which is supposed to receive the data, may respond to the RTS by transmitting a CTS. In case that STA C receives only the RTS sent by STA B and does not receive the CTS sent by STA A, STA C may be aware that STA A is outside the carrier sensing area of STA C. In this case, STA C may determine that transmitting data to another STA (e.g., STA D) will not result in a collision and may transmit data.

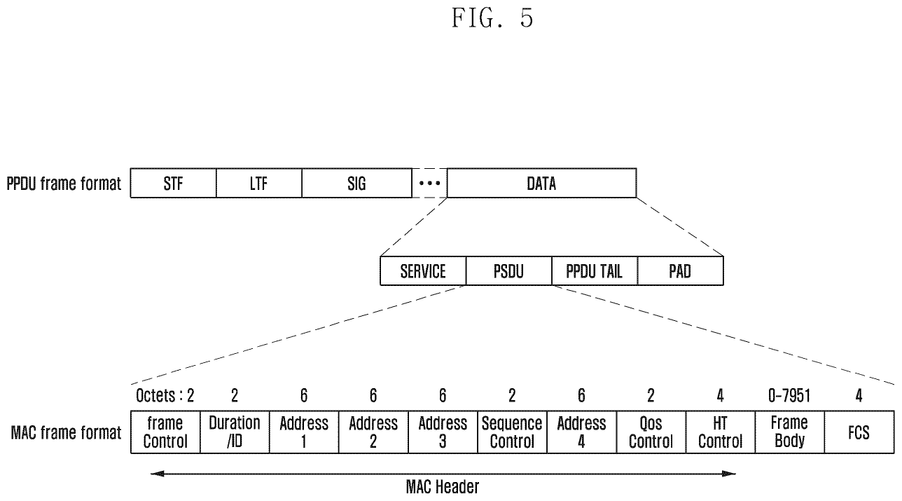

FIG. 5 illustrates an example of a frame structure used in an IEEE 802.11 system according to an embodiment of the disclosure.

A physical layer protocol data unit (PPDU) format may include a short training field (STF), a long training field (LTF), a SIG (SIGNAL) field, and a data field. The most basic (e.g., non-high throughput (HT)) PPDU frame format may include only a legacy-STF (L-STF), a legacy-LTF (L-LTF), a SIG field, and a data field.

The STF may be used for frame timing acquisition, automatic gain control (AGC), diversity detection, and coarse frequency/time synchronization. The LTF may be used for fine frequency/time synchronization and channel estimation. The STF and LTF, in combination, may be referred to as a PHY preamble, and the PHY preamble may serve as a signal for the OFDM physical layer's synchronization and channel estimation.

The SIG field may be used to transmit control information for demodulation and decoding of the data field. The SIG field may include information regarding the data rate and the data length. Additionally, the SIG field may include parity bits, SIG TAIL bits, and the like.

The data field may include a SERVICE field, a physical layer service data unit (PSDU), and PPDU TAIL bits and, if necessary, may include padding bits. Some bits of the SERVICE field may be used for a descrambler at the receiver. The PSDU corresponds to a MAC protocol data unit (MPDU) defined at the MAC layer, and may include data generated/used by the upper layer. The PPDU TAIL bits may be used to return the encoder to a zero state. The padding bits may be used to adjust the length of the data field to a predetermined unit.

The MPDU is defined according to various MAC frame formats, and the basic MAC frame includes a MAC header, frame body, and a frame check sequence (FCS). The MAC frame, configured by an MPDU, may be transmitted/received through the PSDU of the data part of the PPDU format.

The MAC header is defined as an area including a frame control field, a duration/ID field, an address 1 field, an address 2 field, an address 3 field, a sequence control field, an address 4 field, a QoS control field, and an HT control field.

The frame control field includes information regarding the characteristics of the corresponding MAC frame. The duration/ID field may be implemented to have different values depending on the type and subtype of the MAC frame.

The address 1 field through address 4 field are used to indicate the BSSID, the source address (SA), the destination address (DA), the transmitting address (TA) indicating the transmitting STA address, and the receiving address (RA) indicating the receiving STA address.

The sequence control field is configured to include a sequence number and fragment number. The sequence number may indicate the sequence number assigned to the corresponding MAC frame. The fragment number may indicate the number of each fragment of the corresponding MAC frame.

The QoS control field includes information related to the QoS. The QoS control field may be included in case that the subtype subfield indicates the QoS data frame. The HT control field includes control information related to the HT and/or VHT transmit/receive techniques.

The frame body is defined as a MAC payload, where data to be transmitted by the upper layer is located, and has a variable size. For example, the maximum MPDU size may be 11454 octets, and the maximum PPDU size may be 5.484 ms.

The FCS is defined as a MAC footer and is used for the MAC frame's error detection.

The first three fields (frame control field, duration/ID field, and address 1 field) and the last field (FCS field) constitute the minimum frame format and exist in all frames. Other fields may exist only in specific frame types.

The following describes a network allocation vector (NAV) used in a wireless LAN network.

As described above, the CSMA/CA mechanism includes virtual carrier sensing in addition to physical carrier sensing, where an AP and/or an STA directly sense the medium. The virtual carrier sensing is intended to address issues that may arise in medium access, such as the hidden node problem. For the virtual carrier sensing, the MAC of a wireless LAN system may utilize a NAV. The NAV is a value used by an AP and/or an STA currently using the medium or having the right to use the same, to indicate the remaining time until the medium becomes available, to other APs and/or STAs. Therefore, the value configured as the NAV corresponds to the period during which the medium is scheduled for use by the AP and/or the STA that transmits the frame, and STAs that receive the NAV value are prohibited from medium access during that period. The NAV may be configured, for example, based on the value of the duration field in the MAC header of the frame.

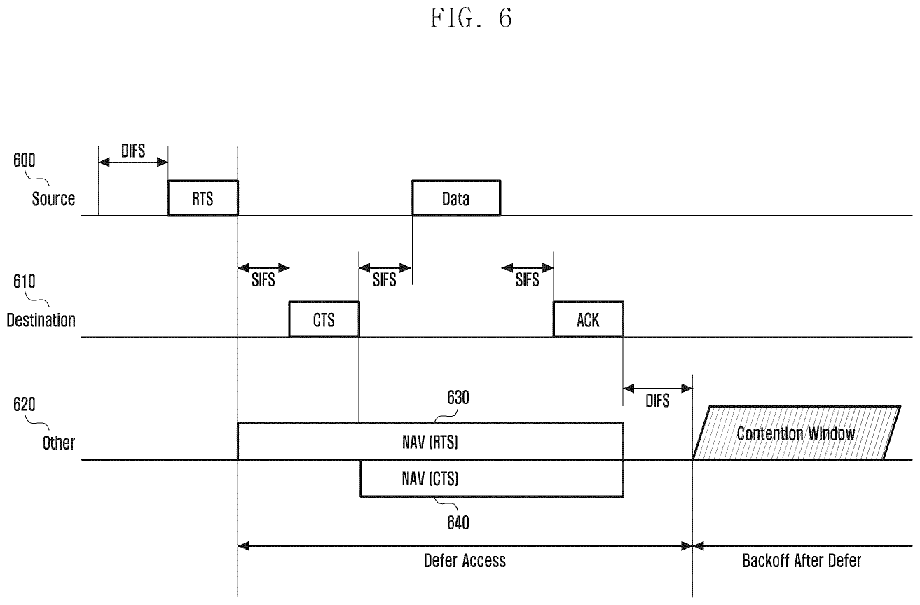

FIG. 6 illustrates an example of a NAV configuration according to an embodiment of the disclosure.

Referring to FIG. 6, the source STA 600 transmits an RTS frame after a DIFS, and the destination 610 transmits a CTS frame after an SIFS. The destination STA designated as the receiver through the RTS frame does not configure a NAV. Among the remaining STAs 620, some may receive the RTS frame and configure a NAV (630), while others may receive the CTS frame and configure a NAV (640).

If a CTS frame (e.g., PHY-RXSTART.indication primitive) is not received within a predetermined period from the timepoint at which the RTS frame is received (e.g., the timepoint at which the MAC received the PHY-RXEND.indication primitive corresponding to the RTS frame), STAs that configured or updated the NAV through the RTS frame may reset the NAV (e.g., to 0) (or such a case may be referred to as a NAVtimeout). The predetermined may be (2*aSIFSTime+CTS_Time+aRxPHYStartDelay+2*aSlotTime), which may be called the NAVtimeout period. The CTS_Time may be calculated based on the length and data rate of the CTS frame indicated by the RTS frame.

Although FIG. 6 illustrates configurating or updating the NAV through an RTS frame or a CTS frame for convenience, the NAV configuration/reconfiguration/update may also be performed based on the duration field (e.g., the duration field in the MAC header of a MAC frame) of various other frames, such as a non-HT PPDU, an HT PPDU, a VHT PPDU, or a HE PPDU.

In addition, in 802.11ax, a basic NAV and an intra-BSS NAV have been introduced. The basic NAV is always configured a NAV by frames transmitted by APs or STAs other than itself (mandatory), and the intra-BSS NAV may be optionally configured as a NAV by frames transmitted within the BSS to which it belongs. An AP or an STA may access the medium in case that both NAV timers have expired (or after the NAV time periods have elapsed).

The following describes a TXOP. A transmission opportunity (TXOP) was newly introduced in the 802.11e MAC to ensure QoS and improve channel utilization. To ensure QoS, the TXOP may be used to allocate an opportunity for transmitting two or more packets belonging to the same access category (AC) preferentially.

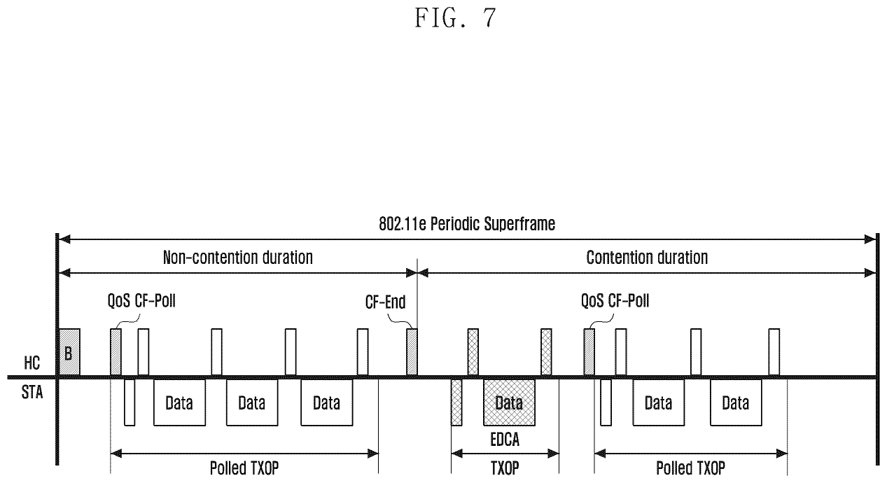

FIG. 7 illustrates an example of the TXOP. A STA participating in QoS transmission may obtain a TXOP such that the same can transmit traffic for a predetermined period, by using two channel access methods, such as EDCA and HCCA according to an embodiment of the disclosure. TXOP acquisition is possible by succeeding in EDCA contention or receiving a QoS CF-Poll frame from an AP, with the former referred to as an EDCA TXOP, and the latter as a polled TXOP. Using the TXOP concept, a predetermined time may be allocated for a STA to transmit frames or the transmission time may be forcibly limited.

The transmission starting time and maximum duration of a TXOP are determined by the AP. This is indicated to the STA by a beacon frame in the case of an EDCA TXOP, and by a QoS CF-poll frame in the case of a polled TXOP.

The NAV may be understood as a type of timer to protect the TXOP of a transmitting STA (e.g., a TXOP holder). A STA may not perform channel access during the period in which the NAV configured therefor is valid, thereby protecting the TXOP of other STAs. In the current wireless LAN system, the TXOP duration is configured through the duration field of the MAC header. That is, the TXOP holder and the TXOP responder (e.g., Rx STA) transmit the entire TXOP information required for frame transmission/reception while being included in in the duration field of frames transmitted/received therebetween. Third STAs other than the TXOP holder or TXOP responder (e.g., third party STAs) identify the duration field of frames exchanged between the TXOP holder and the TXOP responder, and configure/update the NAV, thereby deferring channel use until the NAV period.

The following describes a primary channel and a secondary channel. The primary channel is a common channel operated by all STAs that are members of a BSS. For example, in a 20 MHz, 40 MHz, 80 MHz, 160 MHz, or 80+80 MHz BSS, the primary channel may be a primary 20 MHz channel. In this case, the 40/80 MHz channel including the primary 20 MHz channel may be referred to as a primary 40/80 MHz channel, and the primary channel may generally refer to the primary 20 MHz channel.

The secondary channel is a channel associated with the primary channel, used to create a wider channel than the primary channel. For example, in a 40 MHz, 80 MHz, or 160 MHz BSS, the 40 MHz channel may be the sum of the primary 20 MHz channel and the secondary 20 MHz channel, the 80 MHz channel may be the sum of the primary 40 MHz channel and the secondary 40 MHz channel, and the 160 MHz channel may be the sum of the primary 80 MHz channel and the secondary 80 MHz channel.

The following describes the 802.11be standard. Also known as extremely high throughput (EHT), 802.11be operates in the 2.4, 5, and 6 GHz bands and introduces a 320 MHz bandwidth, 4096QAM, multiple resource units (RUs), and multi-link operations (MLO), thereby providing a maximum speed of 46 Gbps, which is 4.8 times faster than Wi-Fi 6, along with low latency and high network throughput. Specifically, 802.11be offers a 320 MHz bandwidth in the 6 GHz band and can transmit data using MU-MIMO with 16 spatial streams in the uplink and downlink, and adopts 4096QAM to achieve high transmission efficiency. In addition, the same is characterized in that spectrum efficiency is enhanced by flexibly scheduling spectrum resources through multiple RUs, simultaneous data transmission/reception across various frequency bands and channels is possible through multi-link operations.

The following describes TXOP sharing. TXOP sharing, defined in 802.11be, is a concept where an AP transfers the remaining TXOP resources to a STA within the BSS after using the acquired TXOP. The AP may transfer the TXOP to a STA using a multi-user RTS (MU-RTS) TXOP sharing (TXS) trigger frame (TF), i.e., MU-RTS TXS TF, and the STA supposed to receive the TXOP is indicated within the MU-RTS TXS TF. Recently, TXOP sharing between APs has been studied. Through AP-to-AP TXOP sharing, an AP having a TXOP may use it for traffic processing within its own BSS and then share the remaining TXOP with a neighboring AP, thereby efficiently utilizing frequency and spatial resources to increase network throughput and reduce latency. The AP-to-AP TXOP sharing may be referred to as AP TXOP sharing or coordinated TDMA (C-TDMA).

The following describes an overlapping basic service set (OBSS). In conventional wireless LAN networks, performance such as the transmission rate significantly decreases as the number of users increases. This is because wireless LAN systems fundamentally use a CSMA/CA scheme corresponding to time-division access control and, in case that adjacent network is detected, frequency resources in the same band are divided and used for the duration of activity of the adjacent network.

Currently, multiple APs operate in a specific area in many cases, thereby degrading the performance of the wireless LAN network due to overlapping coverage between APs. This happens because the AP of each BSS and the STAs connected to the AP are affected by signals from adjacent BSSs, and the interference with adjacent BSSs causes a reduction in transmission rate due to collisions between signals transmitted at the same time. A BSS that may affect signal transmission (or whose coverage overlaps) can be referred to as an overlapping BSS (OBSS). To address this issue, interference avoidance technology has been researched such that the band available to each user is divided and used to prevent overlapping, or the channel is switched to an unused channel, as well as interference alignment technology that minimize interference impact even when the same band is used.

Hereinafter, the target wake time (TWT) will be described.

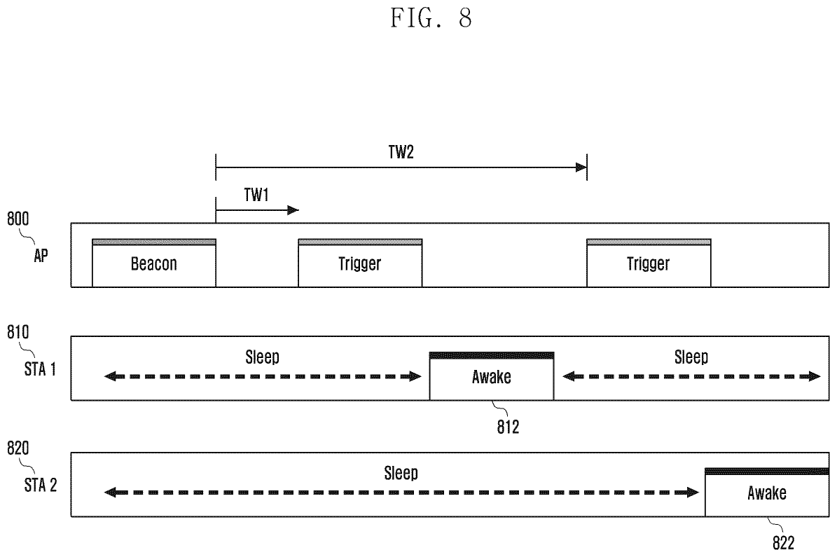

FIG. 8 illustrates an example of the TWT according to an embodiment of the disclosure. The TWT is a technology introduced in 802.11ax to reduce power consumption and enhance spectrum efficiency, particularly usable for IoT applications. The TWT advantageously increases the power-saving time of devices, extends the battery life, and reduces contention for channel access among devices on a shared medium. According to FIG. 8, using the TWT allows each STA 810 and 820 to negotiate awake periods 812 and 822 (i.e., service periods, SP) with the AP 800, enabling data packet to be transmitted/received during the SPs, while the STAs can save energy in the power-saving mode (or sleep mode) during the remaining time. The TWT includes a broadcast TWT mode applied to multiple STAs and an individual TWT mode applied to each STA.

The restricted TWT (R-TWT) is defined in 802.11be to reliably support delay-sensitive traffic within the R-TWT SP. The R-TWT is defined using a reserved bit of a broadcast TWT element and has an additional traffic protection mechanism, compared to conventional the TWT, to ensure successful processing of delay-sensitive traffic to be supported within the R-TWT SP. According to the protection mechanism, the AP and STAs in the BSS may terminate a TXOP at the start of the R-TWT SP to increase the likelihood of the R-TWT SP beginning, or may refrain from initiating a channel access procedure to start a new TXOP in case that (the initiated TXOP) is expected to extend beyond the R-TWT SP start time. That is, an R-TWT-supporting UE in the BSS terminates the ongoing TXOP just before the R-TWT SP begins, in order to ensure that the channel is idle at the R-TWT SP start time operated by the AP, or refrain from starting a new TXOP. In the case of a legacy UE not supporting the R-TWT, the AP may apply a Ims-unit quiet period before the R-TWT SP start time such that the legacy UE does not occupy a TXOP before the R-TWT SP start time. The AP may broadcast the R-TWT schedule to STAs in the BSS in the same manner as the broadcast TWT. That is, the AP advertises the R-TWT schedule through a TWT element included in a management frame (e.g., beacon, probe response). Traffic processed within the R-TWT SP may be limited to traffic matching the R-TWT UL/DL TID.

In the R-TWT, for enhanced shared medium access protection, R-TWT-supporting STAs must terminate all TXOPs at the boundary where the R-TWT SP begins, and assign higher priority to traffic belonging to the membership-specific R-TWT UL/DL TID. This ensures that transmissions by STAs belonging to the membership are guaranteed within the R-TWT SP.

However, in case that an OBSS exists, the (R-)TWT SPs of multiple APs may overlap, and in such cases, transmission of delay-sensitive traffic processed in the R-TWT SP of each BSS may not be guaranteed due to interference from the OBSS. To address this issue, a coordinated R-TWT (C-R-TWT) (or Co-RTWT or C-TWT) may be used, and (R-)TWT schedule information may be shared among multiple APs to this end. Specifically, it is expected that an AP may perform operations of configuring priority for the (R-)TWT schedule and sharing the same, or sharing timing information for AP synchronization, or negotiating overlapping (R-)TWT schedules. In addition, in order to prevent overlap between (R-)TWT SPs, it is anticipated that (R-)TWT rescheduling may be performed, or if overlap cannot be avoided, operations of sharing resources between respective APs may be performed. Hereafter, an AP that performs cooperation (or coordination) to better protect its own R-TWT may be referred to as a sharing AP, and an AP that receives a cooperation request from the sharing AP may be referred to as a shared AP.

Furthermore, various levels of cooperation for performing the C-R-TWT are being discussed. For example, weak-level cooperation may involve an operation in which a shared AP simply refers to the R-TWT of the sharing AP and adjusts its own scheduling, and strong-level cooperation may involve an operation in which the shared AP terminates its TXOP before the start of the R-TWT SP of the sharing AP, and an operation in which the shared AP and its associated STAs all terminate their TXOPs before the start of the R-TWT SP of the sharing AP.

Hereafter, the R-TWT and C-R-TWT, Co-RTWT or C-TWT may be used interchangeably with the TWT. Hereafter, the TWT may include an R-TWT. The TWT may collectively refer to the individual TWT, the broadcast TWT, and the restricted TWT. In the description below, a TWT parameter may be understood as at least one parameter included in the broadcast TWT parameter set field format and the individual TWT parameter set field format. In addition, TWT information or TWT schedule-related information below may also be understood to include at least one of the aforementioned parameters.

As described above, cooperation in the time domain, such as terminating TXOPs to protect the SP of the R-TWT, is primarily discussed as a method for the C-R-TWT. Such operations may be effective as long as APs (or OBSS APS) share the same primary 20 MHz channel. However, in case that APs have different primary 20 MHz channels, it may be unnecessary for a shared AP to terminate its TXOP considering the R-TWT of the sharing AP.

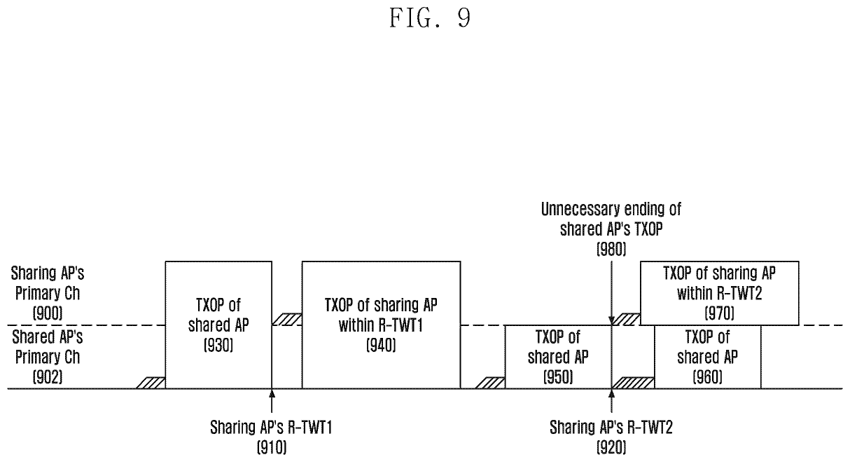

FIG. 9 illustrates an example of C-R-TWT operations in case that APs have different primary channels. Each primary channel may be 20 MHz, but this is not limitative according to an embodiment of the disclosure.

According to FIG. 9, the sharing AP's primary channel 900 and the shared AP's primary channel 902 have different frequency positions (or are frequency-domain multiplexed). The sharing AP has a secondary channel in the position of the shared AP's primary channel 902, and the shared AP has a secondary channel in the position of the sharing AP's primary channel 900.

If the sharing AP's R-TWT1 910 begins, the shared AP may terminate its ongoing TXOP 930. (FIG. 9 assumes a case in which the shared AP may terminate its TXOP to protect the sharing AP's R-TWT.) In addition, the sharing AP occupies a TXOP for R-TWT1 910 (after performing a channel access procedure). As seen in the examples of 930 and 940, in case that the TXOPs of the shared AP and sharing AP overlap in the frequency band, terminating the shared AP's TXOP 930 is necessary to protect the sharing AP's R-TWT1 910.

In case that the shared AP occupies a TXOP 950 (after performing a channel access procedure) on its primary channel 902, the shared AP must terminate its TXOP 950 when the sharing AP's R-TWT2 920 begins. However, if the frequency resource (or frequency band) of the TXOP 970 occupied by the sharing AP for the R-TWT2 does not overlap with the shared AP's TXOP 950, the shared AP terminates its TXOP 980 although there is no need to terminate the TXOP because the same does not affect the sharing AP's R-TWT2. This leads to an inefficient operation where the shared AP performs a new channel access procedure again and occupies a TXOP 960 thereafter.

To address these issues, the disclosure introduces a method and an apparatus in which a shared AP performs the sharing AP's R-TWT using frequency division. To this end, the disclosures proposes a method wherein each AP exchanges its R-TWT information as well as information regarding the frequency band (or frequency bandwidth or channel (or subchannel)) used by the R-TWT, and when the shared AP intends to terminate the TXOP to protect the sharing AP's R-TWT, the shared AP considers the frequency band of the sharing AP's R-TWT and the frequency band of its own TXOP, thereby terminating the TXOP in case that at least a part of the two frequency bands overlaps, thus requiring TXOP termination, and an apparatus configured to perform the method.

According to the disclosed method, the shared AP may protect the traffic transmitted/received in the sharing AP's R-TWT SP without terminating its own TXOP. This increases the channel usage efficiency of the shared AP, and the sharing AP can also perform efficient frequency resource utilization by transmitting traffic using a frequency bandwidth appropriate for the amount of traffic to be transmitted by using the R-TWT.

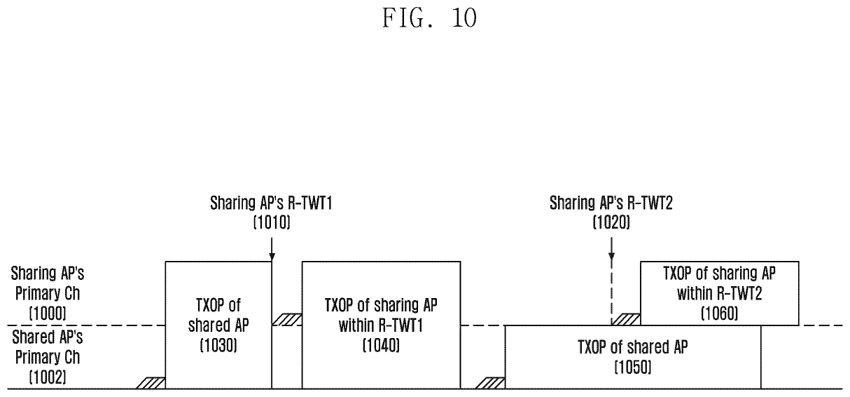

FIG. 10 illustrates an example of an R-TWT protection method in case that APs have different primary channels according to an embodiment of the disclosure. Each primary channel may be 20 MHz, though this is not limitative.

Referring to FIG. 10, the sharing AP's primary channel 1000 and the shared AP's primary channel 1002 have different frequency positions (or are frequency-domain multiplexed). The sharing AP has a secondary channel in the position of the shared AP's primary channel 1002, and the shared AP has a secondary channel in the position of the sharing AP's primary channel 1000.

If the sharing AP's R-TWT1 1010 begins, the shared AP must terminate its ongoing TXOP 1030. In addition, the sharing AP occupies a TXOP (after performing a channel access procedure) for the R-TWT1 1010 (1040). As seen in the examples of 1030 and 1040, in case that the TXOPs of the shared AP and sharing AP overlap in the frequency band, terminating the shared AP's TXOP 1030 is necessary to protect the sharing AP's R-TWT1 1010.

In case that the shared AP occupies a TXOP 1050 (after performing a channel access procedure) on its primary channel 1000, the shared AP confirms, when the sharing AP's R-TWT2 1020 begins, whether the frequency band of its primary channel 1002 or TXOP overlaps with the frequency band of the sharing AP's R-TWT2 1020. The shared AP terminates its TXOP if at least a part of the frequency band of its primary channel or TXOP overlaps with the frequency band of the sharing AP's R-TWT2 1020; otherwise, the shared AP does not terminate the TXOP. In the example of FIG. 10, the frequency band of the shared AP's primary channel or TXOP does not overlap with the frequency band of the sharing AP's R-TWT2 1020, and the shared AP accordingly does not terminate its TXOP 1050. After performing the channel access procedure according to R-TWT2 1020, the sharing AP occupies a TXOP (the frequency band of which does not overlap with the TXOP 1050 of the shared AP) (1060).

Although FIG. 10 shows an example where specific R-TWT and TXOP are configured on an AP's primary channel, the example is not limitative, and the R-TWT and/or TXOP may be configured on a specific AP's primary channel and/or secondary channel. In addition, the bandwidth of each channel may be other than 20 MHz. Furthermore, although the embodiment of the disclosure shown in FIG. 10 is applied to a case in which primary channels do not overlap, the same is also applicable to a case wherein the primary channel and/or secondary channel on which the sharing AP's R-TWT is configured overlaps at least partially with the primary channel and/or secondary channel on which the shared AP's TXOP is configured.

In order to perform the method according to the disclosure, R-TWT information and information regarding the R-TWT's bandwidth (hereinafter interchangeable with terms referring to frequency resources such as frequency bandwidths, frequency bands, channels, or subchannels) must be transmitted to surrounding APs. Hereinafter, a method for transmitting the R-TWT SP's bandwidth-related information to surrounding APs will be described.

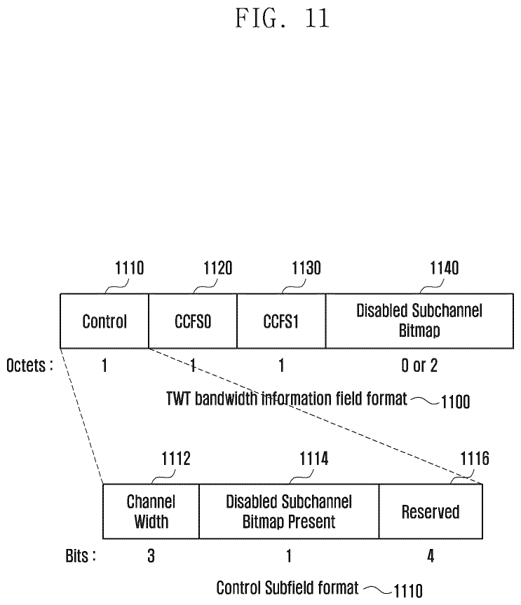

FIG. 11 illustrates an example of a TWT bandwidth information field according to an embodiment of the disclosure.

Referring to FIG. 11, for instance, the TWT bandwidth information field 1100 may include control 1110, channel center frequency segment 0 (CCFS0) 1120, CCFS1 1130, and disabled subchannel bitmap 1140. The names of these fields are merely examples. The control 1110 field may, for example, include a channel width 1112 indicating the channel bandwidth, disabled subchannel bitmap present 1114 indicating whether a disabled subchannel bitmap exists, and reserved 1116. CCFS0 1120 provides information indicating the center frequency of the channel in case that the channel bandwidth is 20, 40, or 80 MHz, while CCFS1 1130 provides information indicating the center frequency of the channel in case that the channel bandwidth is 160 or 320 MHz. In case that the channel bandwidth is 160 or 320 MHz, CCFS0 may also indicate the channel's center frequency. In this case, CCFS1 may be omitted from the TWT bandwidth information field. The disabled subchannel bitmap 1140 provides information related to puncturing, indicating a punctured subchannel in a bitmap format in case that a specific subchannel is punctured and cannot be used. Bits corresponding to punctured subchannels may be configured to 1 and bits corresponding to unpunctured subchannels to 0, and the reverse is also possible. The method of indicating punctured subchannels in a bitmap format is merely an example, and other methods of indicating unusable resources are also possible.

The channel width 1112 may indicate the channel bandwidth as one of 20, 40, 80, 160, and 320 MHz, but this is not limitative. In addition, although FIG. 11 shows an example where the center frequency of the channel is indicated in different fields depending on the channel bandwidth, it is also possible to indicate the center frequency of the channel in a single field regardless of the channel bandwidth. The names of the fields are merely examples and may be modified in a manner understandable to those skilled in the art.

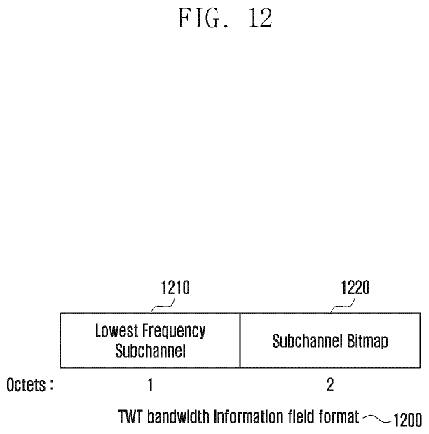

FIG. 12 illustrates another example of the TWT bandwidth information field according to an embodiment of the disclosure.

Referring to FIG. 12, the TWT bandwidth information field 1200 may, for instance, include a lowest frequency subchannel 1210 and a subchannel bitmap 1220. The lowest frequency subchannel 1210 may provide information indicating the channel number of the 20 MHz subchannel having the lowest center frequency among the channels on which the AP operates. The subchannel bitmap 1220 is a bitmap indicating the subchannels required for the R-TWT, where bits corresponding to subchannels used in the R-TWT SP may be configured to 1 and bits corresponding to other subchannels to 0, and the reverse is also possible. In addition, subchannels used in the R-TWT SP may be indicated by methods other than the bitmap. The names of the fields are merely examples and may be modified in a manner understandable to those skilled in the art.

For example, assuming the channel numbers of the subchannels on which the AP operates are 1, 5, 9, 13, 17, 21, 25, and 29 (in the case of 160 MHz), the channel number of the AP's primary 20 MHz channel is 9, and the channel numbers of the subchannels used in the R-TWT are 9 and 13. In this case, the lowest frequency subchannel 1210 field may indicate 1, and the subchannel bitmap 1220 field may be 00110000.

The TWT bandwidth information field described above may be included in a TWT element and transferred to surrounding APs. Hereinafter, an example of the TWT bandwidth information field being included in a TWT element will be described.

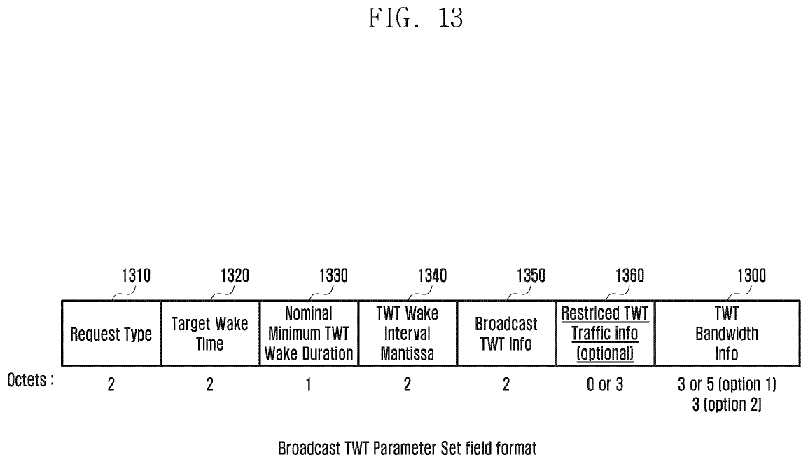

FIG. 13 illustrates an example of including TWT bandwidth information in the broadcast TWT parameter set field for R-TWT according to an embodiment of the disclosure.

In the disclosure, TWT-related information may be transferred through a TWT element. The TWT element format may include a 1-octet element ID field, a 1-octet length field, a 1-octet control field, and a variable-octet TWT parameter information field.

The control field included in the TWT element format may include an NDP paging indicator field, a responder PM mode field, a negotiation type field, a TWT information frame disabled field, a link ID bitmap present field, and an aligned TWT field.

In the case of a broadcast TWT, the TWT parameter information field includes the broadcast TWT parameter set field format shown in 13. The broadcast TWT parameter set field format may include a request type field 1310, a target wake time field 1320, a nominal minimum TWT wake duration field 1330, a TWT wake interval mantissa field 1340, a broadcast TWT info field 1350, a restricted TWT traffic info field 1360, and a TWT bandwidth info field 1300.

Hereinafter, fields included in the broadcast TWT parameter set field format will be described.

### Request Type 1310

The format of the request type field may include a TWT request field, a TWT setup command field, a trigger field, a last broadcast TWT parameter set field, a flow type field, a broadcast TWT recommendation field, a TWT wake interval exponent field, and an aligned field.

The TWT request field has a value of 1 in case that the entity transmitting the TWT element is a TWT requesting STA or a TWT scheduled STA (typically a STA), and a value of 0 in case that the entity is a TWT responding STA or a TWT scheduling AP (typically an AP).

The TWT setup command field refers to the type of TWT command. The TWT setup command field is used for negotiation of the individual TWT or broadcast TWT. Depending on each value, the same is used as follows: Request TWT (value==0), Suggest TWT (value==1), Demand TWT (value==2), TWT Grouping (value==3), Accept TWT (value==4), Alternate TWT (value==5), Dictate TWT (value==6), Reject TWT (value==7).

The trigger field is an indicator of whether a trigger frame is transmitted within the TWT SP. In case that the value thereof is 1, at least one trigger frame must be transmitted.

The last broadcast parameter set field is an indicator of whether the broadcast TWT parameter is the last within the broadcast TWT element. A broadcast TWT element having the last broadcast parameter set value of 1 indicates the last broadcast TWT parameter within the broadcast TWT element.

The flow type field indicates the type of interaction between the TWT requesting STA (or TWT scheduled STA) and the TWT responding STA (or TWT scheduling AP). A value of 0 indicates an announced TWT, requiring the TWT requesting STA (or TWT scheduled STA) to send a power save (PS)-poll or automatic power wave delivery (APSD) trigger frame to indicate its awake state before the TWT responding STA (or TWT scheduling AP) transmits a frame other than a trigger frame. A value of 1 indicates an unannounced TWT, where the TWT responding STA (or TWT scheduling AP) transmits a frame without requiring a PS-poll or APSD from the TWT requesting STA.

The broadcast TWT recommendation field is used to indicate the type of frames that the TWT scheduled STA and TWT scheduling AP may transmit during the broadcast TWT SP.

In case that the broadcast TWT recommendation field value is 0, there are no restrictions on the frames transmitted within the broadcast TWT SP.

In case that the broadcast TWT recommendation field value is 1, it is recommended that frames transmitted within the broadcast TWT SP be limited to a solicited status and solicited feedback (e.g., PS-poll, QoS null frames, feedback included in the QoS control field or HE variant HT control, feedback in HE TB feedback NDP, a bandwidth query report (BQR), a buffer status report (BSR), frames transmitted as part of sounding feedback exchange, control response frames). In addition, trigger frames transmitted by the TWT scheduling AP cannot include RUs for random access.

In case that the broadcast TWT SP field value is 2, it is mostly the same as when the value is 1, with the difference that the trigger frame transmitted by the TWT scheduling AP must include at least one RU for random access.

In case that the broadcast TWT recommendation field value is 3, there are no restrictions except that the AP transmits a TIM frame including a TIM element or a FILS discovery frame at the beginning of each TWT SP.

The TWT wake interval exponent field is used to express the TWT wake interval value. The TWT wake interval is the average time interval between the start times of two consecutive TWT SPs. The TWT interval exponent field represents the exponent value of the TWT wake interval, which is in microsecond units.

TWT wake interval=(TWT wake interval mantissa)×2^{\hat{ }(TWT wake interval exponent)}
Target wake time 1320: the target wake time field refers to a positive integer value corresponding to the time synchronization function (TSF) time at which the STA should be in the wake state.
Nominal minimum TWT wake duration 1330: the nominal minimum TWT wake duration field indicates the minimum time for which the STA must remain awake (i.e., in an active state) for frame exchange within the corresponding TWT SP, with the unit being 256 us.
TWT wake interval mantissa 1340: the TWT interval mantissa field represents the mantissa value of the TWT wake interval, where the unit of the TWT wake interval is microseconds and the base value is 2.
Broadcast TWT info 1350

The broadcast TWT info field may include a restricted TWT traffic info present field, a restricted TWT schedule info field, a broadcast TWT ID field, and a broadcast TWT persistence field.

The restricted TWT traffic info present field indicates whether the restricted TWT traffic info field exists, with a value of 1 indicating its presence. For non-EHT STAs, this field value may be reserved for other purposes.

The restricted TWT schedule info field is included when the restricted TWT parameter set field is transferred to a TWT element having the negotiation type field value of 2. A value of 0 indicates that the corresponding R-TWT schedule is an “idle R-TWT schedule,” meaning there are no member STAs or the schedule is suspended for all STAs.

In case that the restricted TWT schedule info field value is 1, it indicates that the corresponding R-TWT schedule is an active R-TWT schedule, meaning there is at least one member STA within that R-TWT schedule.

In case that the restricted TWT schedule info field value is 2, it indicates that the corresponding R-TWT schedule is a full R-TWT schedule, meaning the resources of the R-TWT schedule are insufficient or there are many existing member STAs, making it difficult to accept new STAs as members.

In case that the restricted TWT schedule info field value is 3, it indicates that the corresponding R-TWT schedule is an advertised R-TWT schedule that has been activated. The same is intended for an AP corresponding to a non-transmitted BSSID corresponding to member of a co-hosted BSSID set or the same multiple BSSID set transmitting the restricted TWT schedule info field.

The broadcast TWT ID field is used as an identifier to refer to a specific broadcast TWT.

The broadcast TWT persistence field is a value expressed as the number of TBTTs representing the time period during which the broadcast TWT SP corresponding to the broadcast TWT parameter set is included. For example, a value of 10 means that the broadcast TWT SP configured with the corresponding parameter is operated for the duration during which 10 beacons are transmitted, while a value of 255 means it is applied permanently.

### Restricted TWT Traffic Info 1360

The restricted TWT traffic info may include a traffic info control field, a restricted TWT DL TID bitmap field, and a restricted TWT UL TID bitmap field.

The restricted TWT DL TID bitmap field and the restricted TWT UL bitmap field respectively represent traffic identifiers (TIDs) identified as latency-sensitive traffic in the downlink and uplink directions in a bitmap format.

The traffic info control field includes a DL TID bitmap valid field, an UL TID bitmap valid field, and a reserved field. The DL TID bitmap valid and UL TID bitmap valid fields indicate whether the restricted TWT DL TID bitmap and restricted TWT UL TID bitmap fields are included, respectively. A value of 1 indicates that the restricted TWT DL TID bitmap or restricted TWT UL TID bitmap field is included in the restricted TWT traffic info field, while a value of 0 indicates that all TIDs are classified as latency-sensitive traffic within the corresponding R-TWT membership.

FIG. 13 illustrates an example in which the TWT bandwidth info field 1300 is always included in the broadcast TWT parameter set field. The TWT bandwidth info field may be the TWT bandwidth info field shown in FIG. 11 or 12, or may be a field including information indicating the bandwidth of the R-TWT SP according to an obvious modification thereof.

Since the TWT bandwidth info field is included in the TWT element that may be included in various frames, related STA(s) may also acquire and use the TWT bandwidth information. This is also advantageous in that the TWT element format used for cooperation and the TWT element format used by non-AP STAs for TWT configurations and the like are identical.

The TWT element according to FIG. 13 may be included in a beacon or an association response for notifying non-AP STAs of broadcast TWT information. The same may also be included in a TWT setup frame for a TWT setup transmitted by an AP or STA for creating, joining, or negotiating a broadcast TWT. In addition, the same may be included in frames transmitted/received between APs for setting up or negotiating the C-R-TWT. APs may transfer information regarding the TWT configured therefor to surrounding APs, and the TWT information may be indicated with a TWT element. The TWT element may include TWT bandwidth information. In case that the TWT bandwidth info corresponds to the example in FIG. 11, the same may be 3 or 5 octets (option 1 in FIG. 13), but this example is not limitative. Alternatively, in case that the TWT bandwidth info corresponds the example in FIG. 12, the same may be 3 octets (option 2 in FIG. 13), but this example is not limitative.

Alternatively, the TWT bandwidth information may be optionally included in the TWT element. For instance, the TWT bandwidth info may be included in the broadcast TWT parameter set field only in case that TWT information is transferred between APs. In this case, a TWT bandwidth info present field indicating whether the TWT bandwidth info is included in the broadcast TWT parameter set field may be added to the broadcast TWT parameter set field. For example, the TWT bandwidth info present field may be included in the trigger, flow type, R-TWT info present, or R-TWT schedule info, or another field or a reserved field included in the broadcast TWT parameter set field may be used to indicate whether the TWT bandwidth info exists. The length of the TWT bandwidth info may be referenced from the descriptions above.

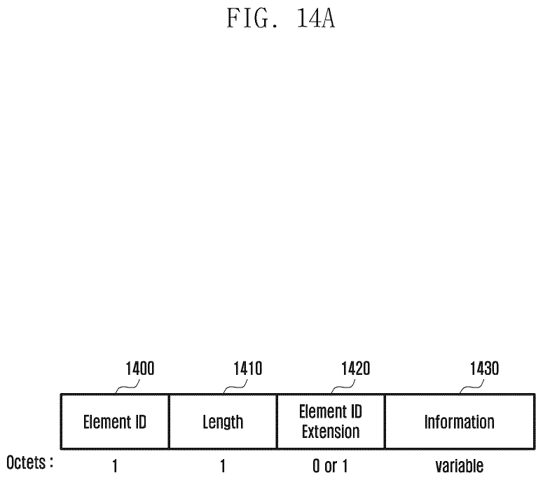

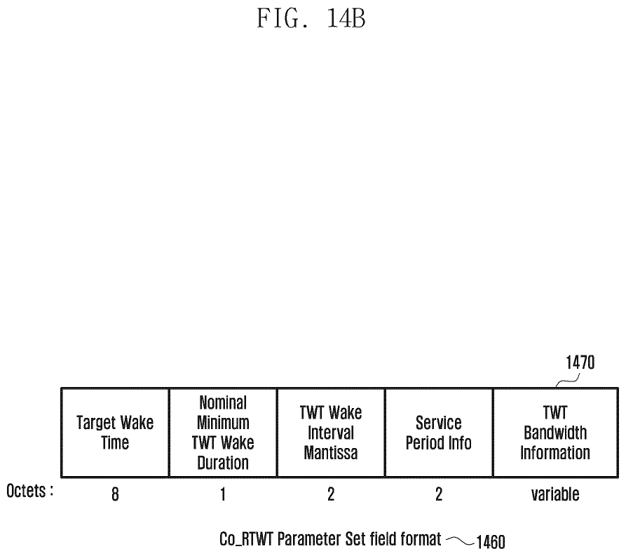

FIG. 14A illustrates an example of a newly defined extended TWT element according to an embodiment of the disclosure. Such an extended TWT element may be transferred to APs and STAs.

Referring to FIG. 14A, the extended TWT element may, for instance, include a 1-octet element ID 1400, a 1-octet length 1410, a 0 or 1-octet element ID extension 1420, and a variable-length octet for information 1430. For example, the element ID may be 255, and with an element ID of 255, the element ID extension may be set to one of the currently unused reserved values. The information field may include TWT bandwidth information, which may, for instance, be the TWT bandwidth info field shown in FIG. 11 or 12.

The extended TWT element of FIG. 14A may also be included in a beacon or an association response. Moreover, the same may be included in a TWT setup frame for a TWT setup transmitted by an AP or STA. Furthermore, the same may be included in frames transmitted/received between APs for setting up or negotiating the C-R-TWT. APs may transfer information regarding the TWT configured therefor to surrounding APs, and the TWT information may be indicated with a TWT element and an extended TWT element including TWT bandwidth information.

FIG. 14B is a diagram illustrating an example in which TWT bandwidth information is included in a multi-AP coordination (MAPC) element exchanged when negotiating or establishing a Co-RTWR between APs according to an embodiment of the disclosure.

In order to negotiate or establish a Co-RTWT, a per-scheme profile subelement including information of the Co-RTWT may be included in the MAPC schemes info of the MAPC element. The per-scheme profile subelement including information for Co-RTWT negotiation may include a Co-RTWT parameter set field 1460 in the MAPC request parameter set field. The Co-RTWT parameter set field 1460 may include the TWT bandwidth information field 1470 as illustrated in FIG. 14B. The TWT bandwidth information field 1470 may be, for example, the TWT bandwidth info field illustrated in FIG. 11 or 12.

The MAPC element may be included in a MAPC discovery request frame, a MAPC discovery response frame, a MAPC negotiation request frame, a MAPC negotiation response frame, or the like transmitted/received between APs.

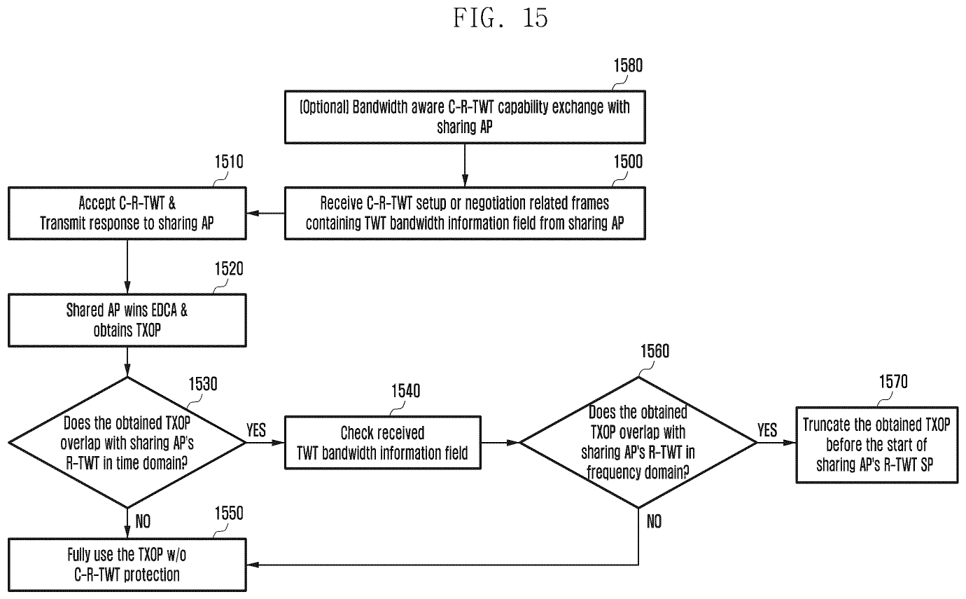

FIG. 15 illustrates an example of operations of a shared AP performing according to an embodiment of the disclosure.

Referring to FIG. 15, the shared AP may exchange capability information indicating possible support for (bandwidth-aware)C-R-TWT which reflects bandwidth information, with the sharing AP at operation 1580. This step may be performed together with step 1500 or in a step in which APs exchange their capabilities or in a step in which APs exchange C-R-TWT-related capability information and configuration information. The shared AP receives a C-R-TWT setup frame or C-R-TWT negotiation-related frame, which contains TWT bandwidth information, from the sharing AP at operation 1500. Specific examples of the TWT bandwidth information may be referenced from the descriptions above. The frame containing TWT bandwidth information is not limited to the frame disclosed at operation 1500, and may correspond to any frame including TWT information transmitted/received between APs. Hereafter, the frame containing TWT bandwidth information received by the shared AP is referred to as a C-R-TWT-related frame, which may include not only TWT bandwidth information but also TWT-related information (e.g., TWT element). Upon receiving the C-R-TWT-related frame, the shared AP transmits a response frame regarding the C-R-TWT-related frame to the sharing AP at operation 1510.

Thereafter, the shared AP accesses the channel through a channel access procedure (e.g., EDCA) and occupies a TXOP at operation 1520. After occupying the TXOP, the shared AP confirms whether the occupied TXOP overlaps at least partially with the sharing AP's R-TWT SP in the time domain at operation 1530. The shared AP may determine the time domain resource of the sharing AP's R-TWT SP, based on the TWT-related information (e.g., TWT element) included in the C-R-TWT-related frame.

In case that the occupied TXOP overlaps at least partially with the sharing AP's R-TWT SP in the time domain, the shared AP identifies the bandwidth (which may be used interchangeably with frequency domain resource, frequency band, channel, subchannel, etc.) of the sharing AP's R-TWT SP, based on the received TWT bandwidth information at operation 1540. Subsequently, the shared AP confirms whether the bandwidth of the occupied TXOP and the bandwidth of the sharing AP's R-TWT SP overlap at least partially in the frequency domain at operation 1560. If the bandwidth of the occupied TXOP and the bandwidth of the sharing AP's R-TWT SP overlap at least partially, the shared AP terminates (or truncates) the obtained TXOP before the start of the sharing AP's R-TWT SP at operation 1570.

In case that the occupied TXOP does not overlap at least partially with the sharing AP's R-TWT SP in the time domain at operation 1530, the shared AP does not need to apply C-R-TWT protection and uses the TXOP without terminating the occupied TXOP at operation 1550. In addition, if the bandwidth of the occupied TXOP and the bandwidth of the sharing AP's R-TWT SP do not overlap at operation 1560, the shared AP does not need to apply C-R-TWT protection and uses the TXOP without terminating the occupied TXOP at operation 1550.

The above-described flowchart illustrates a method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation. The values described above are merely an example, it is sufficiently possible to apply other values.

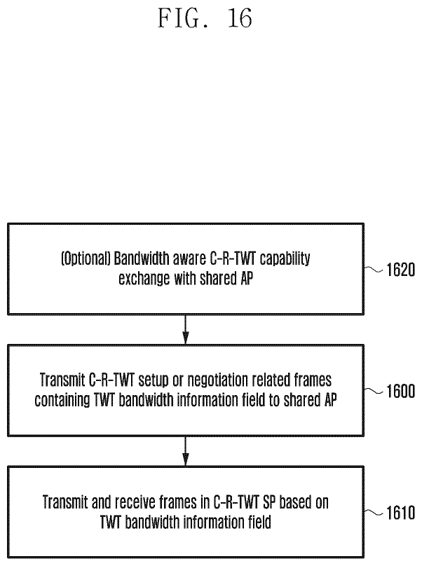

FIG. 16 illustrates an example of operations of a sharing AP performing according to an embodiment of the disclosure.

Referring to FIG. 16, the sharing AP may exchange capability information indicating possible support for (bandwidth-aware)C-R-TWT which reflects bandwidth information, with the shared AP at operation 1620. This step may be performed together with operation 1600 or in a step in which APs exchange their capabilities or in a step in which APs exchange C-R-TWT-related capability information and configuration information. The sharing AP transmits a C-R-TWT setup frame or C-R-TWT negotiation-related frame, containing TWT bandwidth information, to the shared AP at operation 1600. Specific examples of the TWT bandwidth information may be referenced from the descriptions above. The frame containing TWT bandwidth information is not limited to the frame disclosed at operation 1600, and may correspond to any frame including TWT information transmitted/received between APs. Hereafter, the frame containing TWT bandwidth information received by the shared AP is referred to as a C-R-TWT-related frame, which may include not only TWT bandwidth information but also TWT-related information (e.g., TWT element). Subsequently, the sharing AP performs R-TWT operations based on the TWT information and, for instance, transmits/receives frames with STAs related to the sharing AP in the R-TWT SP at operation 1610. The R-TWT SP may be located in the bandwidth (which may be used interchangeably with frequency domain resource, frequency band, channel, subchannel, etc.,) indicated by the TWT bandwidth information.

The above-described flowchart illustrates a method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation. The values described above are merely an example, it is sufficiently possible to apply other values.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate an AP and an STA.

In the drawings in which methods of the disclosure are described, the order of the description does not always correspond to the order in which steps are performed, and the order relationship between the steps may be changed or the steps may be performed in parallel.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first electronic device in a wireless local area network (LAN) network, the method comprising:
receiving a target wake time (TWT)-related frame comprising TWT bandwidth information from a second electronic device;
occupying a transmission opportunity (TXOP);
identifying whether a frequency band of a TWT service period (SP) corresponding to the TWT-related frame, which is to start during occupation of the TXOP, overlaps at least partially with a frequency band of the TXOP; and
terminating the TXOP in case that the frequency band of the TWT SP and the frequency band of the TXOP overlap at least partially,
wherein the frequency band of the TWT SP is identified based on the TWT bandwidth information.

2. The method of claim 1, further comprising:
performing frame transmissions and receptions in the TXOP without terminating the TXOP in case that the frequency band of the TWT SP and the frequency band of the TXOP do not overlap.

3. The method of claim 1, wherein the TWT bandwidth information comprises center frequency information of a channel corresponding to the first electronic device and channel information corresponding to the TWT SP.

4. The method of claim 1, wherein the TWT bandwidth information comprises channel information of a lowest center frequency corresponding to the first electronic device and channel information corresponding to the TWT SP.

5. A method performed by a second electronic device in a wireless local area network (LAN) network, the method comprising:
transmitting a target wake time (TWT)-related frame comprising TWT bandwidth information to a first electronic device; and
transmitting and receiving a frame in a TWT service period (SP) corresponding to the TWT-related frame.

6. The method of claim 5, wherein the TWT bandwidth information comprises center frequency information of a channel corresponding to the first electronic device and channel information corresponding to the TWT SP.

7. The method of claim 5, wherein the TWT bandwidth information comprises channel information of a lowest center frequency corresponding to the first electronic device and channel information corresponding to the TWT SP.

8. A first electronic device in a wireless local area network (LAN) network, the first electronic device comprising:
a transceiver; and
a controller communicatively coupled to the transceiver and configured to:
receive a target wake time (TWT)-related frame comprising TWT bandwidth information from a second electronic device,
occupy a transmission opportunity (TXOP),
identify whether a frequency band of a TWT service period (SP) corresponding to the TWT-related frame, which is to start during occupation of the TXOP, overlaps at least partially with a frequency band of the TXOP, and
terminate the TXOP in case that the frequency band of the TWT SP and the frequency band of the TXOP overlap at least partially,
wherein the frequency band of the TWT SP is identified based on the TWT bandwidth information.

9. The first electronic device of claim 8, wherein the controller is further configured to:
perform frame transmissions and receptions in the TXOP without terminating the TXOP in case that the frequency band of the TWT SP and the frequency band of the TXOP do not overlap.

10. The first electronic device of claim 8, wherein the TWT bandwidth information comprises center frequency information of a channel corresponding to the first electronic device and channel information corresponding to the TWT SP.

11. The first electronic device of claim 8, wherein the TWT bandwidth information comprises channel information of a lowest center frequency corresponding to the first electronic device and channel information corresponding to the TWT SP.

12. A second electronic device of a wireless local area network (LAN) network, the second electronic device comprising:
a transceiver; and
a controller communicatively coupled to the transceiver and configured to:
transmit a target wake time (TWT)-related frame comprising TWT bandwidth information to a first electronic device, and
transmit and receive a frame in a TWT service period (SP) corresponding to the TWT-related frame.

13. The second electronic device of claim 12, wherein the TWT bandwidth information comprises center frequency information of a channel corresponding to the first electronic device and channel information corresponding to the TWT SP.

14. The second electronic device of claim 12, wherein the TWT bandwidth information comprises channel information of a lowest center frequency corresponding to the first electronic device and channel information corresponding to the TWT SP.
